(19) United States
(12) Patent Application Publication
(10) Pub. No.: US 2007/0212528 A1
(43) Pub. Date: Sep. 13, 2007

(54) Process for producing polymer multilayers of segregated nanoparticles

(75) Inventors: Michael E. Mackay, East Lansing, MI (US); Ramachandran Sivaraman Krishnan, Lansing, MI (US)

Correspondence Address: Ian C. McLeod;IAN C. MCLEOD, P.C., 2190 Commons Parkway, Okemos, MI, 48864, US

(73) Assignee: Board of Trustees of Michigan State University, East Lansing, MI (US)

(21) Appl. No.: 11/715,702

(22) Filed: Mar. 8, 2007

Related U.S. Application Data
(60) Provisional application No. 60/780,650, filed on Mar. 9, 2006.

(51) Int. Cl. B32B 27/04

(52) U.S. Cl. 428/206; 977/902

(57) ABSTRACT

A process for producing a multilayered composite composition which has a discrete layer or layers of nanoparticles within a layer of a polymer, is described. The nanoparticles are precipitated in a liquid polymer, preferably, by heating or solubilization of the polymer. The composite compositions are useful for use in photovoltaic devices as well as for in settings where multiple layers are important such as for low gas or liquid permeability films.

### CROSS-REFERENCE TO RELATED APPLICATIONS

This application claims benefit to U.S. Provisional Application Ser. No. 60/780,650, filed Mar. 9, 2006, which is incorporated herein by reference in its entirety.

### STATEMENT REGARDING GOVERNMENT RIGHTS

This invention was supported through NSF CTS-0400840, NSF NIRT-0210247, NSF-CTS-0417640, NSF NIRT-0506309, NSF DMR-0520415, DE-FG02-90ER45418, DE-FG02-05ER46211, ARO W911NF-05-1-0357, and also support by the U.S. Department of Energy, BES-Materials Science, under Contract W-31-109-ENG-38. The U.S. Government has certain rights to this invention.

### BACKGROUND OF THE INVENTION

(1) Field of the Invention

The present invention relates to a process for the production of layers of polymers with segregated layers of nanoparticles, particularly as multilayers. In particular, the present invention provides a process and composite composition wherein an ultra thin coating of a mixture of the nanoparticles and the polymer is annealed at elevated temperatures or in the presence of a solvent for the polymer, so that the nanoparticles migrate to a surface of the polymer to form a nanoparticle layer within the polymer layer. The composite compositions are useful as active photovoltaic films, and low gas or liquid permeability films among other uses.

(2) Description of the Related Art

Self assembled, ultrathin films function as membranes and sensors as well as photovoltaic devices and structural elements, exemplifying their ubiquitous nature and application (Huang, C. H., McClenaghan, N. D., Kuhn, A., Bravic, G. & Bassani, D. M. Hierarchical self-assembly of all-organic photovoltaic devices, Tetrahedron 62, 2050-2059 (2006); Bagkar, N. et al. Self-assembled films of nickel hexacyanoferrate: Electrochemical properties and application in potassium ion sensing, Thin Solid Films 497, 259-266 (2006); Bertolo, J. M., Bearzotti, A., Falcaro, P., Traversa, E. & Innocenzi, P. Sensoristic applications of self-assembled mesostructured silica films, Sensor Letters 1, 64-70 (2003); Pages, X., Rouessac, V., Cot, D., Nabias, G. & Durand, J. Gas permeation of PECVD membranes inside alumina substrate tubes, Sep. Purif. Tech. 25, 399-406 (2001); Ulbricht, M. Advanced functional polymer membranes, Polymer 47, 2217-2262 (2006); Lin, Y., Skaff, H., Emrick, T., Dinsmore, A. D. & Russell, T. P, Nanoparticle assembly and transport at liquid-liquid interfaces, Science 299, 226-229 (2003); Lin, Y. et al. Self-directed self-assembly of nanoparticle/copolymer mixtures, Nature 434, 55-59 (2005); and Lopes, W. A. & Jaeger, H. M. Hierarchical self-assembly of metal nanostructures on diblock copolymer scaffolds, Nature 414, 735-738 (2001)). Layered self-assembly of amphiphilic materials using the Langmuir-Blodgett procedure (Blodgett, K. B. Films built by depositing successive monomolecular layers on a solid surface, J. Am. Chem. Soc. 57, 1007-1022 (1935)) is well known and more recently electrostatically driven Layer-by-Layer or LbL assembly of polymeric multicomposites (Decher, G. Fuzzy nanoassemblies: Toward layered polymeric multicomposites, Science 277, 1232-1237 (1997); and T. H. Cui, F. Hua, Y. Lvov, Sens. Act. a-Phys., 2004, 114, 501) has been demonstrated. In the LbL approach, the fabrication of polymeric multilayers is achieved by consecutive adsorption of polyanions and polycations and hence, is driven by electrostatic forces to achieve monolayers whose thickness is dictated by the polymer geometry. Extension of the LbL method to self-assembly of alternating layers of polymers and nanoparticles significantly extends the scope of this approach (Tang, Z. Y., Kotov, N. A., Magonov, S. & Ozturk, B. Nanostructured artificial nacre, Nature Materials 2,413-U8 (2003)). However, the LbL approach can not be used for non-polar or uncharged nanoparticles and polymers, which excludes a wide range of functional materials.

### OBJECTS

It is therefore an object of the present invention to provide unique multilayered composite compositions wherein nanoparticles are segregated as a layer in a thin film or layer of a polymer. It is further an object of the present invention to provide a process for producing the composite composition which is economical and easy to perform. These and other objects will become increasingly apparent by reference to the following description and the drawings.

### SUMMARY OF THE INVENTION

The present invention relates to a multilayered composite composition with two or more layers joined over each other, wherein at least one of the layers comprises a mixture of:

(a) nanoparticles having a thickness and width of between about 1 and 100 nanometers;

(b) a first layer of a polymer with two opposed sides, wherein the nanoparticles are positioned as at least one of a second layer or additional layers in the polymer at or adjacent to one or both of the sides of the first layer; and

(c) optionally two or more chemically distinct nanoparticles segregate to one or both sides of the second layer. Preferably, wherein each of the first layers is less than about 200 nanometers thick. Most preferably wherein the nanoparticles are comprised of a polymer. Further, wherein the nanoparticles are an inorganic composition. The nanoparticles can be of different chemical composition and may segregate specifically to each side. Still further, wherein one side of one of the multiple layers is on a substrate. Further, wherein the polymer and the spherical nanoparticles are comprised of the same or similar chemical composition as the polymer. Further still, wherein the mixture of the polymer as a liquid and the nanoparticles have been coated on a surface and then precipitated onto or adjacent to one of the sides or segregated at an opposite of the sides to provide the first layer of the polymer with the second layer of the nanoparticles. Preferably, wherein the mixture of the polymer as a liquid and the nanoparticles have been coated on a surface and then precipitated onto or adjacent to the one of the sides or segregated at an opposite of the sides to provide the first layer of the polymer with the second layer of the nanoparticles on one or both of the sides, and wherein the precipitation or segregation has resulted from a heating and cooling step. Most preferably, wherein the mixture of the polymer as a liquid and the nanoparticles have been coated on a surface and then precipitated onto or adjacent to the one of the sides or segregated at an opposite of the sides to provide the first layer of the polymer with the second layer of the nanoparticles on one or both of the sides, and wherein the precipitation or segregation is by means of a solvent vapor solubilizing the first polymer layer without solubilizing the nanoparticles so that the nanoparticles are precipitated or segregated. In addition, whereupon, the above entails two chemically dissimilar nanoparticles that segregate to opposite sides of the polymer film.

Further, the present invention relates to a process for forming a multilayered composition with two or more layers over each other, wherein each layer comprises a mixture of: nanoparticles having a thickness of between about 1 and 100 nanometers; and a first layer of a polymer with two opposed sides, wherein the nanoparticles are positioned as at least one of a second layer or additional layers in the polymer at one or both of the sides of the first layer, the steps comprising: for at least one of the multilayers precipitating or segregating the nanoparticles as the second layer in the polymer as a liquid onto a surface and then solidifying the polymer to form the first layer and optionally repeating the steps for additional of the multilayers. Further, wherein each of the first layers is less than about 200 nanometers thick. Still further, wherein the nanoparticles are comprised of a polymer or an inorganic composition. Further still, wherein one side of one of the layers is on a substrate. Preferably, wherein the polymer and the spherical nanoparticles are comprised of the same or similar chemical composition. Most preferably, wherein the first layer is with the nanoparticles spin-coated onto the surface. Further, wherein the first layer with the nanoparticles is spin-coated onto the surface and wherein the nanoparticles are precipitated or segregated by heating and then cooling the first layer with the nanoparticles. Finally, wherein the nanoparticles are precipitated or segregated by solubilizing the polymer layer with a solvent without solubilizing the nanoparticles.

Two different types of nanoparticles can segregate to the two sides of the layer.

### BRIEF DESCRIPTION OF THE DRAWINGS

FIG. 1 is a schematic drawing of the preferred process of the present invention for forming the multiple layers. The nanoparticle can segregate to the top interface or two different nanoparticle types may go to different sides of the first layer (film).

FIG. 2 is a labeled TEM image showing the multiple layers and showing a line of the precipitated nanoparticles as a dark line of CdSe nanoparticle layers between each of the polymer layers.

FIG. 3A is a graph showing reflectivity (R) multiplied by reflectance wave vector (Q) to the fourth power (RQ⁴) vs Q for a silicon wafer with a thin film (˜40 nm) of polymer-nanoparticle mixture before and after annealing to demonstrate that polystyrene nanoparticles migrate to the solid substrate. The solid lines represent the fits for the before and after annealed films as described in the text while the dotted line represents the reflectivity profile after the nanoparticles migrated to the air interface. FIG. 3B is a graph showing nanoparticle concentration profile determined from the scattering density profile for the “after annealing” film shown in FIG. 3A. In FIG. 3B, a scaled representation of the nanoparticle is placed in the lower right hand corner. FIG. 3C is a schematic drawing showing spin coating process to make the multilayered films. FIG. 3D is a graph showing RQ⁴ vs Q for a silicon wafer spin coated with three layers of cross-linked polystyrene and polystyrene nanoparticles. FIG. 3D shows the fit (solid line) corresponding to six alternating layers of hydrogenated polymer and deuterated nanoparticle (see inset) while the dotted line is the prediction when the nanoparticles were homogeneously distributed. The thickness of each polymer-nanoparticle layer is approximately 44 nm.

FIG. 4A is a transmission electron micrograph (TEM) of an assembly of 16 layers: 8 CdSe quantum dots (QDs) alternating with 8 cross-linked polystyrene layers, assembled on a silicon wafer. Each bilayer is numbered on the micrograph from 1 to 8. In all the micrographs, a gold layer was sputtered on the film after fabrication to mark the air interface and mask the uppermost quantum dot layer. FIG. 4B shows a six-layer assembly made by assembling QDs and polystyrene (layer 1)=, pure polystyrene (layer 2), QDs and polystyrene (layer 3), and finally pure polystyrene (layer 4). The inset in FIG. 4B shows a TEM micrograph of the first layer normal to the substrate surface demonstrating a reasonably uniform film. FIG. 4C shows an assembly of 8 layers: 4 QDs and 4 polystyrene where the quantum dot layers are thicker than previous assemblies and the polystyrene are thinner (both ˜15 nm).

FIG. 5A shows optical micrographs of a 58 nm thick polystyrene (PS) film floated onto a 56 nm thick PMMA film after thermal aging on a silicone (Si) wafer with its native oxide layer (SiO₂). Isolated polystyrene drops can be seen on the surface of PMMA. FIG. 5B shows a PMMA film floated on polystyrene subject to the same annealing procedure given in FIG. 5A to show a similarly unstable film. The instabilities shown in FIGS. 5A and 5B disappear in FIGS. 5C and 5D, respectively, when the top layer is replaced by a composite film composed of both the precipitated quantum dots (QDs) and the polymer. The film ordering is given in the figure with the abbreviations listed above; the length of the scale bar is 200 μm. FIG. 5E is a graph showing reflectivity profile of 25 kDa hydrogenated nanoparticles (NPs) blended with 60 kDa partially deuterated NPs shows that before annealing the film is homogeneous while after thermal annealing the 25 kDa NPs assemble at the air interface rather than at the substrate.

FIG. 6 is a TEM image showing a layer with large quantum dot nanoparticles.

### DESCRIPTION OF THE PREFERRED EMBODIMENTS

Materials

The term “multiple” as used herein means two or more layers.

The term “polymer” means a polymer which can be in liquid form to mix the nanoparticles into the polymer and which can be a solid at room temperature. The polymers can be inorganic silicon based polymers or organic carbon based polymers. The polymer can be thermoplastic or thermosetting.

The term “nanoparticles” means particles which are 100 nm or less in thickness. Preferably, the nanoparticles are spherical with a diameter of 100 nm or less.

Nanoparticle-polymer layers are assembled in a controllable manner dictated by the difference in nano-object morphology and dielectric properties. A thin (of order 10-100 nm) layer of the two components is spin coated onto a solid substrate and the system thermally aged to activate a cross-linking process between polymer molecules or a similar process which makes the layer robust to subsequent layer deposition that can include use of another non-solvent for the original layer. The nanoparticles segregate to the solid substrate prior to complete cross-linking if entropic forces are dominant or to the air interface if dielectric (surface energy) forces are active. Subsequent layers are then spin coated onto the layer below, and the process is repeated to create layered structures with nanometer accuracy useful for tandem solar cells, sensors, optical coatings, etc. Unlike other self-assembly techniques, the layer thickness are dictated by the spin coating conditions and relative concentration of the two components.

Self-assembly of nonpolar linear polymers and nanoparticles into layers with controllable, thickness can be fully realized using relatively simple and robust processing steps. Moreover, by controlling entropic and enthalpic driving forces, controlled self-assembly of nanocomponent multilayers is demonstrated, promoting facile manufacture of a wide range of biomimetic (Sellinger, A. et al. Continuous self-assembly of organic-inorganic nanocomposite coatings that mimic nacre, Nature 394, 256-260 (1998)) and other fascinating (Murahashi, T. et al. Discrete Sandwich Compounds of Monlayer Palladium Sheets, Science 313, 11-4-1107 (2006)) nanostructures from nonpolar materials.

Self-assembly of non-polar, uncharged polymers and nanoparticles is strongly influenced by entropic effects; however, local enthalpic terms and long range dispersion forces can also be significant. Kinetic effects such as jamming and self-assembly during drying are also important in some situations effectively trapping the structures. (Huang, J. X., Kim, F., Tao, A. R., Connor, S. & Yang, P. D. Spontaneous formation of nanoparticle stripe patterns through dewetting. Nature Materials 4, 896-900 (2005); Bigioni, T. P. et al. Kinetically driven self assembly of highly ordered nanoparticle monolayers. Nature Materials 5, 265-270 (2006); and Stratford, K., Adhikari, R., Pagonabarraga, I., Desplat, J. C. & Cates, M. E. Colloidal jamming at interfaces: A route to fluid-bicontinuous gels. Science 309, 2198-2201 (2005)) We first show that entropic effects due to architecture differences (Adams, M., Dogic, Z., Keller, S. L. & Fraden, S. Entropically driven microphase transitions in mixtures of colloidal rods and spheres. Nature 393, 349-352 (1998)) can drive self-assembly of multilayers by using unique polystyrene nanoparticle—linear polystyrene mixtures where the difference in monomer—monomer enthalpic effects are minimized. Here the nanoparticles assemble at the solid substrate without jamming to maximize the system entropy. We then show that multilayers formed from CdSe quantum dots and linear polystyrene are controlled by the interplay between surface energy, dispersion forces and entropy. In this system, the nanoparticles primarily segregate to the air interface yet multilayer fabrication remains facile. A third example consisting of a multilayer of two incompatible polymers, namely linear polystyrene and linear polymethylmethacrylate (PMMA), where CdSe quantum dots are used to stabilize the multilayer, displaying the capability of our processing technique to incorporate a wide range of polymer and nanoparticle combinations. We also show that different sized nanoparticles segregate into two layers pushing the larger nanoparticles to the solid substrate demonstrating the technique can be used with architecturally and chemically dissimilar systems as well as with systems with chemical similarity but size dissimilarity.

We have recently shown, (Krishnan, R. S., Mackay, M. E., Hawker, C. J. & Van Horn, B. Influence of molecular architecture on the dewetting of thin polystyrene films, Langmuir 21, 5770-5776 (2005)) using neutron reflectivity experiments, that polystyrene nanoparticles made by an intramolecular collapse strategy (Harth, E. et al. A facile approach to architecturally defined nanoparticles via intramolecular chain collapse, J. Amer. Chem. Soc. 124, 8653-8660 (2002); and Tuteja, A., Mackay, M. E., Hawker, C. J., VanHorn, B. & Ho, D. L. Molecular Architecture and Rheological Characterization of Novel Intramolecularly Crosslinked Polystyrene Nanoparticles, J. Poly. Phys.: Poly. Phys. 44, 1930-1947 (2006)) blended with linear polystyrene, are uniformly distributed in a spuncast thin film (ca. 40 nm thick). Yet, after annealing the film above the glass transition temperature of the linear polymer, they were found to segregate to the solid substrate. Separate experiments with different deuteration contrast ruled out migration of nanoparticles due to any isotopic effect (Hariharan, A., Kumar, S. K. & Russell, T. P. Reversal Of The Isotopic Effect In The Surface Behavior Of Binary Polymer Blends, J. Chem. Phys. 98, 4163-4173 (1993); and Jones, R. A. L., Kramer, E. J., Rafailovich, M. H., Sokolov, J. & Schwarz, S. A. Surface Enrichment in an Isotopic Polymer Blend, Phys. Rev. Lett. 62, 280-283 (1989)). Also, since the nanoparticles and linear polymer have identical repeat units (styrene monomer), adverse monomeric enthalpic interactions between the linear polymer and the nanoparticles are minimal, (Mackay, M. E. et al. General strategies for nanoparticle dispersion, Science 311, 1740-1743 (2006)) and the migration of the nanoparticles to the solid substrate is primarily an entropic effect (Yethiraj, A. Entropic and Enthalpic Surface Segregation From Blends Of Branched And Linear-Polymers, Phys. Rev. Lett. 74, 2018-2021 (1995)). Nanoparticle localization to an interface (Lee, J. Y., Buxton, G. A. & Balazs, A. C. Using nanoparticles to create self-healing composites, J. Chem. Phys. 121, 5531-5540 (2004); and Tyagi, S., Lee, J. Y., Buxton, G. A. & Balazs, A. C., Using nanocomposite coatings to heal surface defects, Macromolecules 37, 9160-9168 (2004)) has great utility since it changes a range of physical and mechanical properties of thin films, in particular it inhibits their dewetting from low energy substrates, (Krishnan, R. S., Mackay, M. E., Hawker, C. J. & Van Horn, B. Influence of molecular architecture on the dewetting of thin polystyrene films, Langmuir 21, 5770-5776 (2005); Barnes, K. A., Douglas, J. F., Liu, D. W. & Karim, A. Influence of nanoparticles and polymer branching on the dewetting of polymer films, Adv. Coll. Int. Sci. 94, 83-104 (2001); and Barnes, K. A. et al. Suppression of dewetting in nanoparticle-filled polymer films, Macromolecules 33, 4177-4185 (2000); and Mackay, M. E. et al. Influence of dendrimer additives on the dewetting of thin polystyrene films, Langmuir 18, 1877-1882 (2002)) a phenomenon we use in the present work.

In the preferred process, a solution containing the polymer and nanoparticle or a highly branched polymer was coated onto a substrate by spin coating, dip coating or any technique that can create a thin film of order 10-100 nm in thickness. The film was then aged by heating above its softening point or through exposure to solvent vapor which similarly softens the film on both treatments. The nanoparticles or a highly branched polymer molecule then segregate to the substrate with the polymer layer on top creating a bilayer. Other layers were assembled on top of this bilayer by cross-linking the polymer film or chemically modifying the polymer to make it subsequently insoluble or coating another polymer-nanoparticle/highly branched polymer mixture dissolved in a non-solvent for the original layer. The aging process was repeated as can be the layering process.

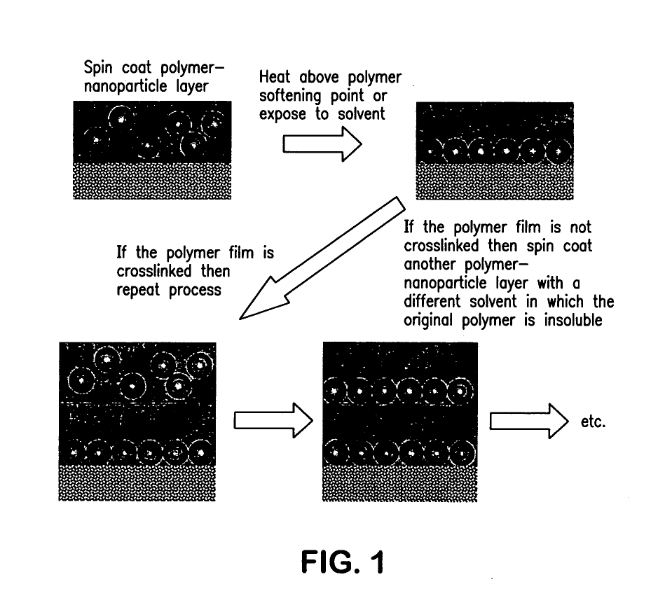

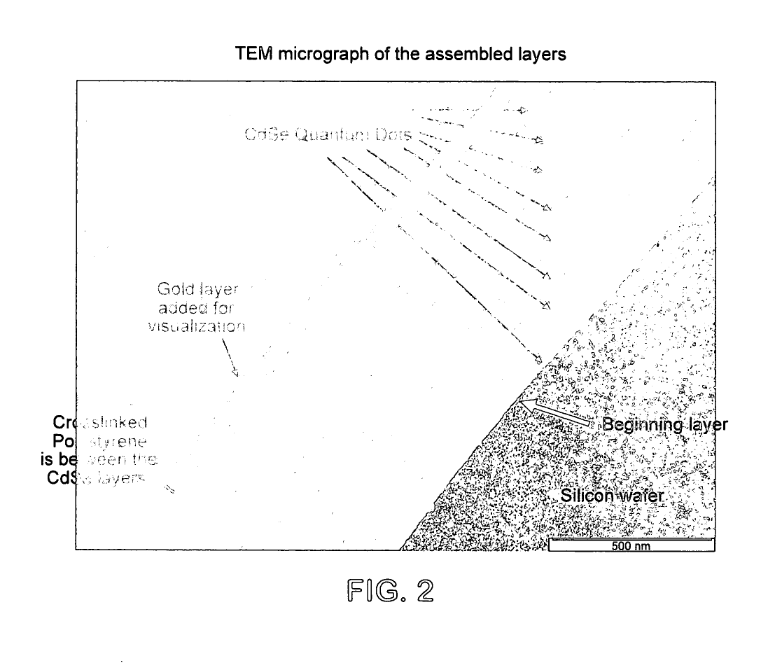

FIG. 1 shows the steps in the process and FIG. 2 shows an eight (8) layered composite composition of cross-linking polystyrene and CdSe nanoparticles prepared by this process.

The preferred process produces a composite composition which comprises in admixture: spherical particles having a diameter between about 1 to 100 nanometers; and a polymer, as a layer with two sides, wherein the nanoparticles are positioned as a second layer or adjacent to one or both of the sides. The particles can comprise an inorganic material. The particles can comprise an organic material. The particles can be a layer on the substrate. The particles in the polymer are preferably as a layer adjacent to the substrate and/or at the opposite interface. The composite composition preferably has multiple layers.

The present invention also relates to a process for producing a composite composition which comprises admixing the nanoparticles uniformly into a liquid polymer, coating the liquid polymer as a first layer on a substrate, heating and or solubilizing the polymer on the substrate to precipitate the nanoparticles within the first layer as a second layer on or adjacent to the substrate to provide the composite layer and then solidifying the polymer. In the method, multiple of the thin film layers with the layer of the nanoparticles which are deposited one on top of the other. Depending on the application, the polymer can be a liquid that remains stable in the multilayer structure.

Two prerequisites for facile control of multilayer fabrication are the ability to uniformly disperse nanoparticles in thin films (Krishnan, R. S., Mackay, M. E., Hawker, C. J. & Van Horn, B. Influence of molecular architecture on the dewetting of thin polystyrene films, Langmuir 21, 5770-5776 (2005)) and then to control their segregation to either the substrate or air surface or both. It is shown first that a thin film initially composed of a uniform mixture of polystyrene nanoparticles and polystyrene can be annealed to form a bilayer consisting of a nanoparticle rich phase at the solid substrate and a polymer rich phase at the air interface. It is then shown that this process may be repeated, enabling proficient and well controlled fabrication of multilayers, and that similar processing may be used for a wide range of nanoparticle and polymer combinations. The process is called the Self Assembled Multilayers of Nanocomponents or SAMON.

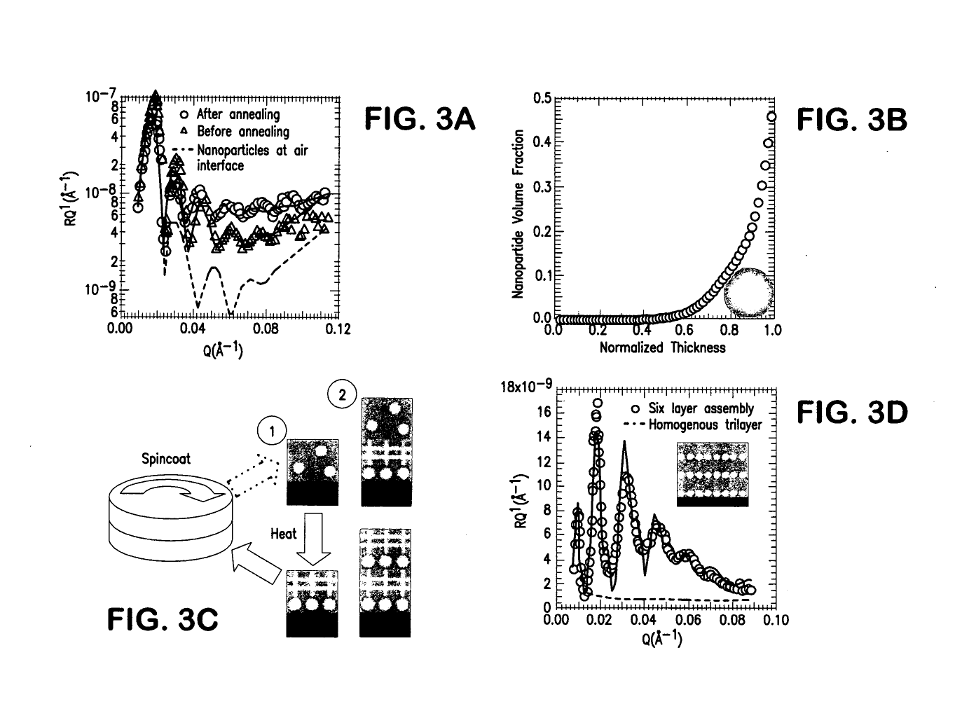

The process of entropy driven enrichment of polystyrene nanoparticles at the silicon wafer substrate is demonstrated in FIG. 1A where neutron reflectivity measurements (RQ⁴ vs. Q, R is the reflectance and Q, the wave vector) on a polymer film containing 10 wt % polystyrene nanoparticles (211 kD) blended with deuterated linear polystyrene (63 kD) show a distinct change before and after annealing. If the polymer or nanoparticle contains deuterium by stating it is deuterated, if no isotopic substitution is made, then no mention of hydrogen content is made. The d₈ linear polystyrene was purchased from Scientific Polymer Products and the polystyrene nanoparticles were made by collapsing and cross-linking a random copolymer of 20 mol % benzylcyclobutane (BCB) and 80 mol % styrene as discussed by Harth et al. (Harth, E. et al., A facile approach to architecturally defined nanoparticles via intramolecular chain collapse, J. Amer. Chem. Soc. 124, 8653-8660 (2002)). Before annealing, the ca. 40 nm thick film, that was spin-coated from a benzene solution, was accurately modeled as a single layer with a homogeneous nanoparticle distribution corresponding to an average scattering length density (SLD) of 5.92×10⁻⁶ Å⁻², the solid line in the figure demonstrates the goodness of the fit to the data. Here the SLD of the pure deuterated polymer and that of the nanoparticle is 6.42×10⁻⁶ Å⁻² and 1.41×10⁻⁶ Å⁻², respectively. The reflectivity profile undergoes a profound change after annealing for 2 h at 160° C. as demonstrated by the data presented in FIG. 3A along with the results of using a two layer model with a nanoparticle rich layer at the solid substrate. Note the nanoparticle surface coverage is approximately one-half a monolayer in this example, as determined by a simple mass balance assuming that all the nanoparticles are located at the substrate, (Krishnan, R. S., Mackay, M. E., Hawker, C. J. & Van Horn, B. Influence of Molecular architecture on the dewetting of thin polystyrene films, Langmuir 21, 5770-5776 (2005)) as confirmed by the reflectivity measurement.

The solid line in FIG. 3A corresponds to a model where the top layer consists of the pure deuterated linear polymer and the bottom layer contains a combination of the deuterated linear polymer and the nanoparticles with an interface roughness of 5 nm comparable to the nanoparticle diameter (2a) of approximately 8.8 nm. The results of using an alternative model where the nanoparticles segregate to the air interface yields the dotted line in FIG. 3A. This data and further analysis, using a range of models, clearly indicates that the nanoparticles migrate to the solid substrate after high temperature annealing. This is further illustrated in FIG. 3B, where the concentration profile of the annealed film has been extracted from the reflectivity data. A scaled representation of the nanoparticle is also shown in the lower right-hand corner of this figure.

To fabricate multiple polymer-nanoparticle layers, stacked on top of each other, functionalization and cross-linking of each layer was accomplished by spin-coating an 85 wt % polymer −15 wt % nanoparticle blend on top of a previously aged and cross-linked film via the procedure shown in FIG. 3C. The numbers 1, 2, etc. in the figure represent addition of a new layer. The polymer was a 211 kD random copolymer of 80 mol % styrene and 20 mol % BCB stabilized from dissolution during the subsequent spin-coating operation by heating to 230° C. for 24 h to activate the cross-linking process between BCB groups. Subsequent experiments demonstrated a significantly decreased aging time is actually required. The 78 kD partially deuterated, cross-linked polystyrene nanoparticles are found to segregate to the substrate or cross-linked polymer layer below prior to completion of the cross-linking process, allowing repetition of this procedure two more times to give a six layer system with each bilayer being about 44 nm in thickness. Note the nanoparticles were synthesized according to the procedure previously described (Harth, E. et al., A facile approach to architecturally defined nanoparticles via intramolecular chain collapse, J. Amer. Chem. Soc. 124, 8653-8660 (2002)) except the styrene monomer was deuterated while the BCB was not. The segregation was confirmed by neutron reflectivity measurements (FIG. 3D), where modeling confirmed six layers, demonstrated by the inset, with the nanoparticles at the solid substrate in each bilayer. Modeling the nanoparticle distribution as if they were homogeneously distributed shown by the dotted line in the figure, or at the air interface (not shown), gives a poor fit to the data showing that the neutron reflectivity data strongly supports the nanoparticle segregation illustrated in the inset.

In this system, segregation of the nanoparticles is driven by an entropy gain for the entire system which has been shown to be important when cracks form in nanoparticle filled polymers. (Gupta, S., Zhang, Q. L., Emrick, T., Balazs, A. C. & Russell, T. P. Entropy-driven segregatio of nanoparticles to cracks in multilayered composite polymer structures. Nature Materials 5, 229-233 (2006)) Yet, one expects a translational entropy loss when a nanoparticle segregates to the substrate, which is approximately k_{B}T per nanoparticle, where k_{B} is Boltzmann's constant and T, temperature. We also found in our previous work (Mackay, M. E. et al., General strategies for nanoparticle dispersion, Science 311, 1740-1743 (2006)) that each nanoparticle gains approximately [a/σ]²×ε worth of enthalpic contact energy between the nanoparticle and polymer when it is dispersed in the polymer. Here ε is the components' monomeric interaction energy and σ is the monomer size, so the nanoparticle loses both enthalpic contacts with the polymer chains and translational entropy due to segregation. This loss is countered by the conformational entropy gain of moving the linear polystyrene chains away from the substrate. An estimate of this entropy gain is αk_{B}T×[a/σ]³, with α representing the degrees of freedom gained by a monomer unit when it is released from substrate constraints. In writing this term, we note that the conformational entropy gain of the linear chain on moving away from the substrate is proportional to the volume of the nanoparticle, a result which is valid provided the nanoparticle is smaller than the radius of gyration of the linear chains. In order for segregation to occur, the conformational entropy gain of the polymer should be greater than the translation entropy and mixing enthalpy losses of the nanoparticle or
α[a/σ]³>1+[a/σ]²×ε/k_{B}T
where ε/k_{B}T is of order 0.1-1 for dispersion forces. Since a and σ are of order 1-10 nm and 0.1 nm, respectively, then α must be greater than order 0.01-0.1 to allow this segregation. This is reasonable, since a monomer unit on a linear chain may gain up to one degree of freedom on constraint release, in which case α=1.

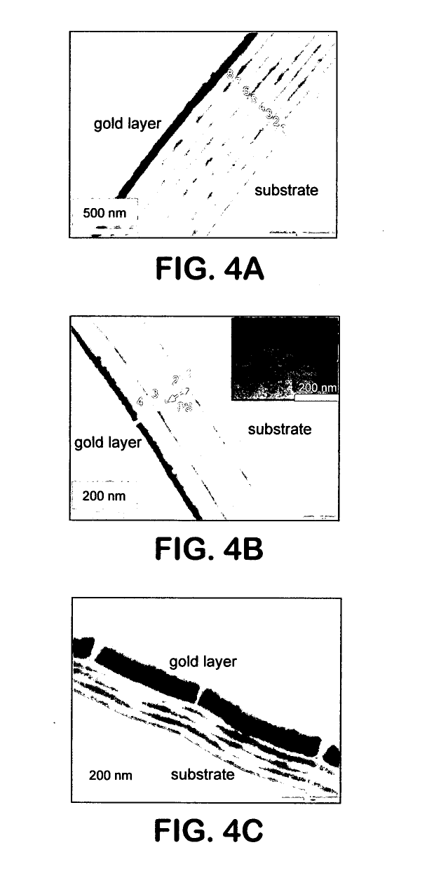

The versatility of this process is further demonstrated by the ability to replace the polystyrene nanoparticles with inorganic-based materials. Though the above entropic and enthalpic terms are always important in nanoparticle segregation, other enthalpic terms play an important role for these systems. Dispersion of CdSe quantum dots in non-polar polystyrene is made possible by attachment of oleic acid chains to the quantum dot surfaces to yield a sterically stabilized system that is soluble in toluene. The quantum dots were synthesized using a previously published procedure (S. Asokan, K. M. Krueger, A. Alkhawaldeh, A. R. Carreon, Z. Z. Mu, V. L. Colvin, N. V. Mantzaris, M. S. Wong, Nanotechnology, 2005 16, 2000) that involves injection of a selenium-trioctylphosphine solution into a heated (250° C.) CdO—oleic acid—heat transfer fluid solution and allowing the reaction to progress for ca. 1 h. Phase segregation of the quantum dots from linear polystyrene, in thin films, is clearly evident in transmission electron microscopy (TEM) images shown in FIGS. 4A to 4C. We note that these quantum dots are completely soluble in bulk polystyrene, as occurs for others systems where nanoparticle architecture enables bulk miscibility, with a particularly notable case being dendritic polyethylene (Z. Guan, P. Cotts, E. McCord, S. McLain, Science 1999, 283, 2059) in polystyrene (Mackay, M. E. et al., General strategies for nanoparticle dispersion, Science 311, 1740-1743 (2006)).

The TEM image in FIG. 4A shows eight bilayers self-assembled with the SAMON process (FIG. 3C) using the same linear polystyrene as above, having 20 mol % BCB groups that can be cross-linked. Each quantum dot layer is close to a monolayer coverage (approximately ˜5 nm thick) and the thickness of each polymer layer is about 75 nm.

The quantum dots primarily assemble at the air interface in this system with the exception of the first layer, layer 1 in the figure, where they are at both interfaces. This is made clear by viewing FIG. 4B which has the following layer deposition scheme: layer 1, polymer+quantum dots; layer 2, pure polymer; layer 3, polymer+quantum dots; layer 4, pure polymer; with each layer being processed by thermal aging after spin-coating to activate the cross-linking process before the subsequent layer is deposited. Some quantum dots have assembled at the substrate interface in layer 1, yet, most have segregated to the air interface. This is more evident by viewing the interface between layers 2 and 3 and 3 and 4. Here it is clear that the quantum dots in layer 3 have mostly gone to the air interface which is subsequently covered by a pure, cross-linked polymer layer.

The assembly is easily described by careful consideration of the Hamaker constant for trilayers making-up a multilayer assembly. If the constant is negative then that trilayer is stable with the effective interface potential positive to ensure stability (Seemann, R. et al. Dynamics and structure formation inthin polymer melt films. J. Phys. -Cond. Mat. 17, S267-S290 (2005)). If we consider a trilayer of air (component 1)—quantum dots (3)—polystyrene (2) then one can determine the sign of the Hamaker constant (A₁₃₂) using, (Israelachvili, J. N. Intermolecular and Surface Forces (Academic Press, New York, 1992)) A₁₃₂˜[n₁²-n₃²]×[n₂²-n₃²], which is a good heuristic for non-conducting materials. Here nᵢ is the refractive index of component i with the following approximate values: 1.0 (air), 1.54 (quantum dots) and 1.59 (polystyrene). The value for the quantum dots' refractive index was arrived at by computing a volume average of a CdSe inner core with a 2.2 nm radius (refractive index of 2.8) surrounded by an oleic acid layer which is 2.5 nm thick (refractive index of 1.4). The oleic acid layer thickness was determined by dynamic light scattering of a dilute toluene solution and is a reasonable value based on the chemical structure. With these values, the ordering of air—quantum dots—polystyrene is stable while others are not.

Of course, this type of assembly requires similar forces as described by Gupta et al. (Gupta, S., Zhang, Q. L., Emrick, T., Balazs, A. C. & Russell, T. P. Entropy-drive segregation of nanoparticles to cracks in multilayered composite polymer structures. Nature Materials 5, 229-233 (2006)) However, since the nanoparticles are presumably homogeneously dispersed after the initial spin-coating step, they must rapidly diffuse to form the stable configuration before dewetting occurs. Using the Stokes-Einstein relation and the viscosity for the polystyrene melt (Fox, T. G. & Flory, P. J. Viscosity-molecular weight and viscosity-temperature relationships for polystyrene and polyisobutylene. J. Am. Chem. Soc. 70, 2384-2395 (1948)) a diffusion coefficient of ca. 50 nm²/s is calculated. Since the layer thickness is of order 50 nm then approximately one minute is required for the nanoparticles to diffuse to either interface. This time scale is so small we believe the dewetting behavior is stabilized throughout the diffusion process as nanoparticles rapidly accumulate to their stable configuration thereby prohibiting nucleation and growth of holes. Nevertheless, some nanoparticles are trapped at the unstable position, for example near the substrate, either due to the entropic stabilization or by kinetic means where local cross-linking confines them at the given position. This later hypothesis seems unlikely since we have not observed quantum dots trapped in the middle of the film (FIG. 4B).

Much thicker quantum dot layers and thinner polymer layers can also be formed as demonstrated in FIG. 4C where ca. 15 nm thick quantum dot layers have been assembled with ˜15 nm thick cross-linked polystyrene. Again, the first layer shows a thin quantum dot layer at the substrate with most of them located at the upper part of this film. Subsequent films show alternating layers of the two components which are not as coherent as the layers formed with a lesser amount of quantum dots, FIGS. 4A and 4B as well as the inset of FIG. 4B, although they are certainly distinct. We believe the layers can be further refined through optimization of the processing conditions.

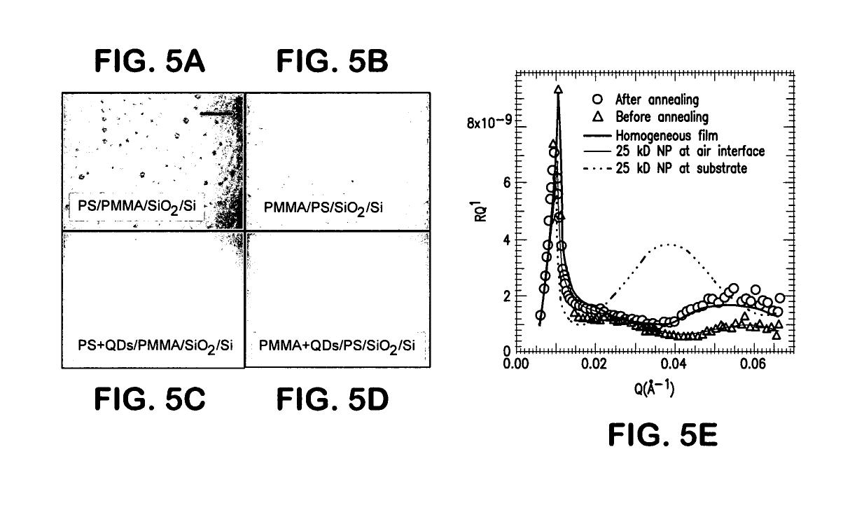

Generalization of the SAMON technique to incompatible, uncross-linked polymers and nanoparticles is demonstrated in FIGS. 5A to 5D where optical micrographs of PMMA and polystyrene polymers are considered. The first layer, either PMMA (76 kD, FIG. 5A) or polystyrene (75 kD, FIG. 5B), was spin-coated onto the silicon wafer, that has its native oxide layer, followed by floating the other polymer on top and aging the composite for 24 h at 180° C. Both systems were found to dewet as expected, however, when the top layer contained quantum dots the dewetting was eliminated as shown in FIGS. 5C and 5D. Previous work has demonstrated that other nanoparticles will slow the dewetting dynamics, (Xavier, J. H. et al. Effect of nanoscopic fillers on dewetting dynamics. Macromolecules 39, 2972-2980 (2006)) however, our work shows complete elimination of dewetting. So, the SAMON process applies to a wide range of polymers, and stabilization may be carried out both with or without cross-linking the polymer layer yielding a robust procedure for self-assembly of functional multilayers from non-polar nanoparticles and polymers.

The process can be extended to different sized nanoparticles (Zeng, H., Li., J., Liu, J. P., Wang, Z. L. & Sun, S. H. Exchange-coupled nanocomposite magnets by nanoparticle self-assembly. Nature 420, 395-398 (2002)) in FIG. 5E. A blend of two cross-linked polystyrene nanoparticles, differing in molecular size, were spin-coated together on a silicon wafer at an overall and relative concentration to yield a monolayer of the larger nanoparticle and a bilayer of the smaller. One component was a cross-linked random copolymer of 80 mol % styrene-20 mol % BCB to form a nanoparticle (25 kD molecular mass, radius ˜2.3 nm) while the other nanoparticle had four styrene monomer units deuterated and the final BCB unit remained hydrogenated (60 kD molecular mass, radius ˜3.1 nm). Thermal aging was performed and it was found that the larger nanoparticles segregated to the solid substrate in agreement with recent simulations (Roth, R. & Dietrich, S. Binary hard-sphere fluids near a hard wall. Phys. Rev. E 62, 6926-6936 (2000)). This effect is caused by a system entropy gain since there are fewer larger particles near the wall per unit volume and hence less translational entropy loss for the system occurs as a whole. We tried another size ratio of nanoparticles, 3.1 nm and 4.1 nm radius, without significant success. A slight change in the homogeneous neutron reflectivity profile is seen after high temperature aging, yet, the difference is within experimental error and so delicate packing effects are apparent or the nanoparticles are in a jammed state. Rheological characterization shows the two larger size nanoparticle systems (3.1 nm and 4.1 nm radius) have a yield stress while the smallest system (2.3 nm radius) does not (A. Tuteja, M. E. Mackay, C. J. Hawker, B. VanHorn, D. L. Ho, J. Poly. Phys.: Poly. Phys. 2006, 44, 1930-1947) which may trap the system into a kinetically stabilized state. Regardless, we have developed a process to produce assembly on the nanoscale based on size dissimilarity as well as architectural.

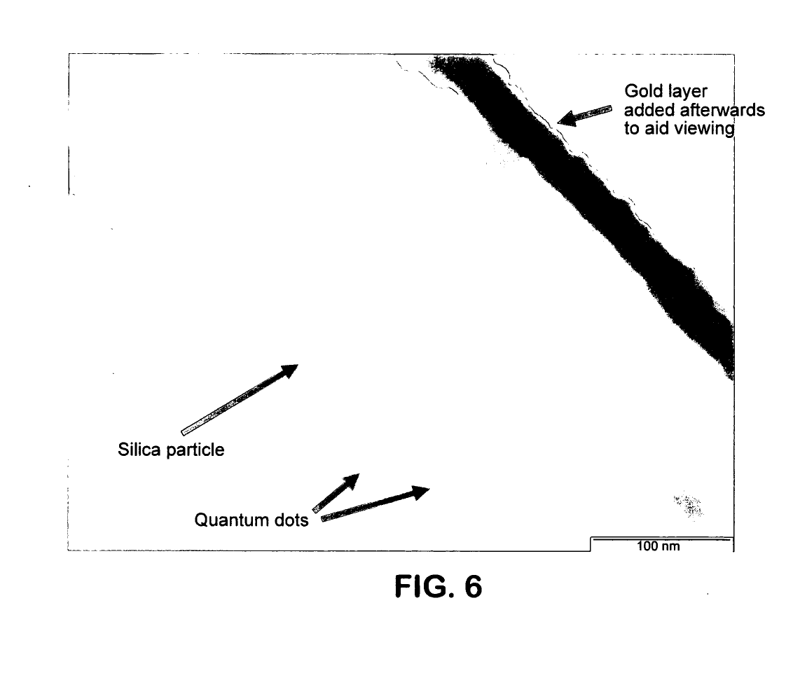

Larger particles have been placed on a surface and then spin coated with a layer of nanoparticles/polymer on it. It is then heated and the quantum dots self assemble around the big particle and on the substrate. This makes a high area interface because of the larger particles (see FIG. 6). A solar cell for example with a higher interfacial area, would mean a more efficient cell. If the quantum dot nanoparticles were not present, then the polymer dewets (beads up) and it does not work.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

We claim:

1. A multilayered composite composition with two or more layers joined over each other, wherein at least one of the layers comprises a mixture of:
(a) nanoparticles having a thickness and width of between about 1 and 100 nanometers;
(b) a first layer of a polymer with two opposed sides, wherein the nanoparticles are positioned as at least one of a second layer in the polymer at or adjacent to one or both of the sides of the first layer; and
(c) optionally two or more chemically distinct nanoparticles segregate to one or both sides of the second layer.

2. The composite composition of claim 1 wherein each of the first layers is less than about 200 nanometers thick.

3. The composite composition of claim 1 wherein the nanoparticles are comprised of a polymer.

4. The composite composition of claim 1 wherein the nanoparticles are an inorganic composition.

5. The composite composition of claim 1 wherein one side of one of the multiple layers is on a substrate.

6. The composite composition of claim 1 wherein the polymer and the spherical nanoparticles are comprised of the same or similar chemical composition as the polymer.

7. The composite composition of any one of claims 1, 2, 3, 4, 5 or 6 wherein the mixture of the polymer as a liquid and the nanoparticles have been coated on a surface and then precipitated onto or adjacent to one of the sides or segregated at an opposite of the sides to provide the first layer of the polymer with the second layer of the nanoparticles.

8. The composite composition of any one of claims 1, 2, 3, 4, 5 or 6 wherein the mixture of the polymer as a liquid and the nanoparticles have been coated on a surface and then precipitated onto or adjacent to the one of the sides or segregated at an opposite of the sides to provide the first layer of the polymer with the second layer of the nanoparticles on one or both of the sides, and wherein the precipitation or segregation has resulted from a heating and cooling step.

9. The composite composition of any one of claims 1, 2, 3, 4, 5 or 6 wherein the mixture of the polymer as a liquid and the nanoparticles have been coated on a surface and then precipitated onto or adjacent to the one of the sides or segregated at an opposite of the sides to provide the first layer of the polymer with the second layer of the nanoparticles on one or both of the sides, and wherein the precipitation or segregation is by means of a solvent vapor solubilizing the first polymer layer without solubilizing the nanoparticles so that the nanoparticles are precipitated or segregated.

10. A process for forming a multilayered composition with two or more layers over each other, wherein each layer comprises a mixture of:
nanoparticles having a thickness of between about 1 and 100 nanometers; and a first layer of a polymer with two opposed sides, wherein the nanoparticles are positioned as at least one of a second layer or additional layers in the polymer at one or both of the sides of the first layer, the steps comprising:
for at least one of the multilayers precipitating or segregating the nanoparticles as the second layer in the polymer as a liquid onto a surface and then solidifying the polymer to form the first layer and optionally repeating the steps for additional of the multilayers.

11. The process of claim 10 wherein each of the first layers is less than about 200 nanometers thick.

12. The process of claim 10 wherein the nanoparticles are comprised of a polymer.

13. The process of claim 10 wherein the nanoparticles are an inorganic composition.

14. The process of claim 10 wherein one side of one of the layers is on a substrate.

15. The process of claim 10 wherein the polymer and the spherical nanoparticles are comprised of the same or similar chemical composition.

16. The process of claim 10 wherein the first layer is with the nanoparticles spin-coated onto the surface.

17. The process of claim 10 wherein the first layer with the nanoparticles is spin-coated onto the surface and wherein the nanoparticles are precipitated or segregated by heating and then cooling the first layer with the nanoparticles.

18. The process of claim 10 wherein the nanoparticles are precipitated or segregated by solubilizing the polymer layer with a solvent without solubilizing the nanoparticles.
